(19) United States
(12) Patent Application Publication
(10) Pub. No.: US 2013/0328959 A1
(43) Pub. Date: Dec. 12, 2013

(54) IMAGE FORMING APPARATUS

(71) Applicant: NK WORKS CO., LTD., Wakayama (JP)

(72) Inventors: Toshiro AKIRA, Wakayama (JP); Akihito YAMAMOTO, Wakayama (JP); Hisashi OMORI, Wakayama (JP)

(73) Assignee: NK WORKS CO., LTD., Wakayama (JP)

(21) Appl. No.: 13/897,859

(22) Filed: May 20, 2013

(30) Foreign Application Priority Data
Jun. 12, 2012 (JP) 2012-133139

(51) Int. Cl. B41J 11/00

(52) U.S. Cl. CPC B41J 11/0005
USPC 347/16

(57) ABSTRACT

An image forming apparatus includes a conveying section for withdrawing and conveying a printing medium stored in the form of a roll, a printing section for effecting a printing operation on the printing medium, a decurling device for correcting curling in the printing medium and a controlling section. The decurling device is disposed on the downstream side of the printing section. The controlling section controls such that a decurling operation to be effected before the printing operation and a decurling operation to be effected after the printing operation are effected by the decurling device.

### BACKGROUND OF THE INVENTION

1. Field of the Invention

The present invention relates to an image forming apparatus for effecting a printing operation on a printing medium stored in the form of a roll.

2. Description of the Related Art

A printing medium stored in the form of a roll has a curling (curling peculiarity). When such printing medium is used in an image forming apparatus for printing of an image, there occurs deterioration in the commercial value. Further, when an image forming apparatus having a print head which is moved back and forth, there is a risk that the print head may come into contact with the curled portion inadvertently. Therefore, it is desired to correct such curling.

As a device for correcting (to be referred to as “decurling” hereinafter) such curling in a printing medium, there is known a decurling device configured to apply a correcting force after printing (Japanese Unexamined Patent Application Publication No. 2009-179416).

The decurling device disclosed in this Japanese Unexamined Patent Application Publication No. 2009-179416 is disposed on the downstream side of a printing section and for a printing medium after printing, correction of curling is effected, using a decurling roller.

However, a printing medium stored in the form of a roll has a curling even prior to printing, so there is a problem that the printing medium may come into contact with the print head at the time of starting of printing. Further, there is a risk that quality deterioration occurs if printing is effected with curling remaining in the medium.

With the decurling device disclosed in Japanese Unexamined Patent Application Publication No. 2009-179416, the device is capable of effecting decurling of only printing medium after printing, so this problem cannot be solved.

On the other hand, it is conceivable to provide a decurling mechanism on the upstream side of the printing section so that printing is effected after correction of curling in the printing medium. In this case, however, two decurling mechanisms are required, so there will occur such problem as cost increase.

In view of the above-described state of the art, an object of the present invention is to provide an image forming apparatus capable of effecting decurling of a printing medium before and after printing while restricting cost increase.

### SUMMARY OF THE INVENTION

For accomplishing the above-noted object, an image forming apparatus according to the present invention comprises:

a conveying section for withdrawing and conveying a printing medium stored in the form of a roll;

a printing section for effecting a printing operation on the printing medium;

a decurling device for correcting curling in the printing medium; and

a controlling section;

wherein the decurling device is disposed on the downstream side of the printing section; and

the controlling section controls such that a decurling operation to be effected before the printing operation and a decurling operation to be effected after the printing operation are effected by the decurling device.

With the above-described arrangement, since curling in the printing medium before printing can be corrected, there occurs no interference between the print head and the curled portion, so that the printing may be effected on the printing medium whose curling has been corrected. Also, as the corrections before and after printing are effected by the same decurling device, there is no need to provide two decurling devices and cost increase can be restricted.

Further, according to one preferred embodiment of the image forming apparatus of the present invention, the controlling section effects control such that the decurling operation before printing is effected only on the leading end portion of the printing medium.

With the above-described arrangement, since the decurling operation to be effected before printing is effected only on the leading end portion of the printing medium where curling appears conspicuously, the period required for this decurling operation before printing can be shortened.

According to one preferred embodiment of the image forming apparatus of the present invention, the controlling section effects control such that the decurling operation before printing and the decurling operation after printing are effected with different correcting forces.

With the above-described arrangement, even when the intensity of curling differs between before printing and after printing, the corrections can be effected in accordance with the respective intensities.

According to one preferred embodiment of the image forming apparatus of the present invention, the image forming apparatus further comprises a curling detecting section for detecting presence/absence of the curling at the leading end portion of the printing medium; and

the controlling section effects control such that the decurling operation before printing is effected only when curling is detected at the leading end portion of the printing medium.

With the above-described arrangement, the decurling operation before printing is not effected when no curling is present at the leading end portion of the printing medium. So, the printing operation can be started immediately, so that waste of time can be reduced. Incidentally, the above language “the absence of curling” is understood to be inclusive of a condition of a curling smaller than a predetermined amount being present.

According to one preferred embodiment of the image forming apparatus of the present invention, the image forming apparatus further comprises a curling intensity detecting section for detecting the intensity of the curling in the printing medium; and the controlling section effects control such that the correcting force for the decurling operation before printing is varied according to the intensity of the curling.

With the above-described arrangement, even when the curling of the printing medium before printing has various intensities, the decurling operation can be effected in an effective manner.

### BRIEF DESCRIPTION OF THE DRAWINGS

FIG. 1 is a side view in section of an image forming apparatus,

FIG. is a perspective view of a printing section,

FIG. 3 is a plane view of the printing section,

FIG. 4 is a side view in section of the printing section,

FIG. 5 is a view showing a decurling mechanism under a condition when no decurling operation is effected,

FIG. 6 is a view showing the decurling mechanism under a condition when a decurling operation is effected,

FIG. 7 is a view showing the decurling mechanism under a condition when a decurling operation is effected, and

FIG. 8 is a flowchart showing flow of a printing controlling operation according to an embodiment.

### DETAILED DESCRIPTION OF THE PREFERRED EMBODIMENT

[General Construction]

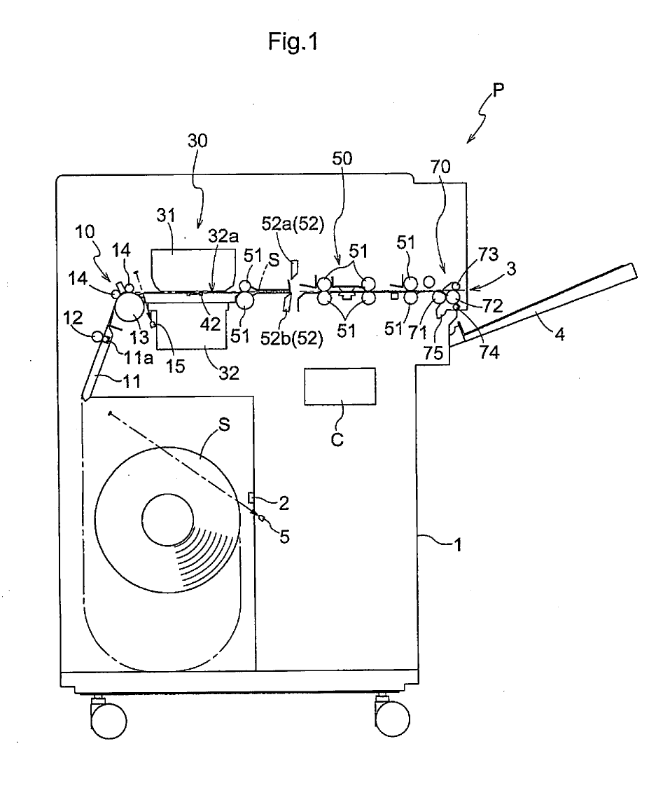

Next, an embodiment of the present invention will be explained with reference to the accompanying drawings. FIG. 1 is a side view in section of an image forming apparatus P according to the instant embodiment. The image forming apparatus P according to the embodiment includes a box-like casing 1. Inside the casing 1, there are provided, as seen from the upstream side in the conveying direction, a first conveying section 10, a printing section 30, a second conveying section 50, and a decurling mechanism 70. The first conveying section 10 withdraws a printing medium S in the form of a roll and feeds it to the printing section 30. The printing section 30 forms an image on the printing medium S fed thereto. The second conveying section 50 conveys the printing medium S with the recorded image toward the decurling mechanism 70. The decurling mechanism 70 corrects curling peculiarity (decurls) of the printing medium S and discharges it through a discharge opening 3.

Inside the casing 1, there is also provided a controlling section C for controlling operations of the entire image forming apparatus P. The controlling section C can be comprised of a CPU or a microcomputer.

[Printing Medium]

At a lower section inside the casing 1, the printing medium S in the form of a roll is stored. The roll-like printing medium S employed in the instant embodiment is provided with information indicating a serial product number (this will be referred to as “product number information” hereinafter) and in the vicinity of the storage position of the printing medium S, there is provided a product number information reading section 2 for obtaining this product number information. As a means for holding or recording the product number information, a barcode, an RFID tag or the like can be employed. On the other hand, as the product number information reading section 2, there can be employed any device suitable as a means for holding/recording a product number information employed, such as a barcode reader, an RFID reader, etc. The product number information read by the product number information reading section 2 is transmitted to the controlling section C.

Further, inside the casing 1, there is also provided a non-volatile storage medium (not shown) such as a flash memory, accessible from the controlling section C. The non-volatile storage medium stores therein the product number information and property information such as paper quality of the printing medium S corresponding to this product number information, in correlation with each other. Accordingly, as the controlling section C obtains product number information from the product number information reading section 2, the controlling section C can obtain the property information of the stored printing medium S.

The image forming apparatus P according to the instant embodiment includes a roll radius (roll diameter) detecting section 5 for detecting a roll radius of the roll-like printing medium S. This roll radius detecting section 5 detects the radius (roll radius) of the printing medium S currently stored and transmits the result to the controlling section C. In the instant embodiment, the roll radius detecting section 5 is comprised of a photo interrupter. The roll radius detecting section 5 determines whether the roll radius of the currently stored printing medium S is greater or smaller than a predetermined value and then transmits the result of this determination to the controlling section C. With this, the controlling section C can recognize the radius of the printing medium S on which an image is to be formed, at the time of its rolled state and the curvature of the printing medium S at the time of its rolled state. In the instant embodiment, the roll radius detecting section 5 constitutes the curling intensity detecting section in the context of the present invention.

[First Conveying Section]

The first conveying section 10 is provided between the storage position of the printing medium S and the printing section 30 and withdraws the roll-like printing medium S and conveys this toward the printing section 30.

The first conveying section 10 includes a guide member 11 for guiding the printing medium S upwards. The guide member 11 includes a driven roller 11a embedded therein. Further, at a position in opposition to the driven roller 11a, a conveyer roller 12 is provided. In operation, the printing medium S is provided with a conveying force by the conveyer roller 12, thus being conveyed along the guide member 11.

Downstream in the conveying direction of the guide member 11, there are provided an advance roller 13 and two driven rollers 14. In operation, the printing medium S which has been guided from the downward side by the guide member 11 is guided along the horizontal direction by the advance roller 13 and the two driven rollers 14 to be conveyed to the side of the printing section 30.

Between the advance roller 13 and the printing section 30, there is provided a leading end detecting section 15 for detecting the leading end of the printing medium S. This leading end detecting section 15 transmits result of detection of the leading end of the printing medium S to the controlling section C. Then, based on this leading end detection result of the printing medium S, the controlling section C controls the timing of printing operation of the printing section 30. Incidentally, in the instant embodiment, the leading end detecting section 15 comprises a photo interrupter. However, this section 15 may comprise other sensor or the like.

[Printing Section]

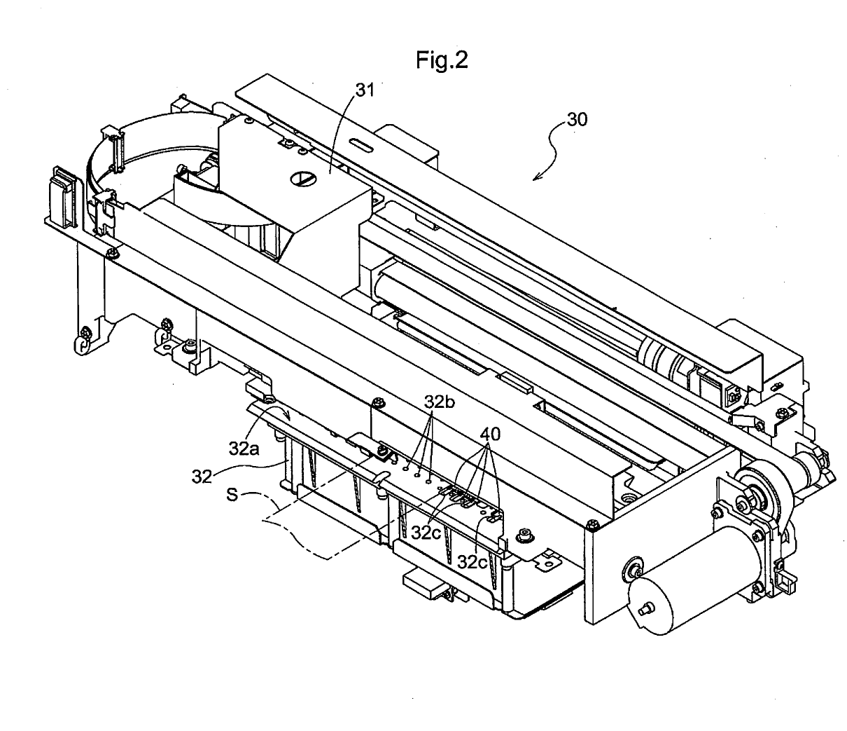

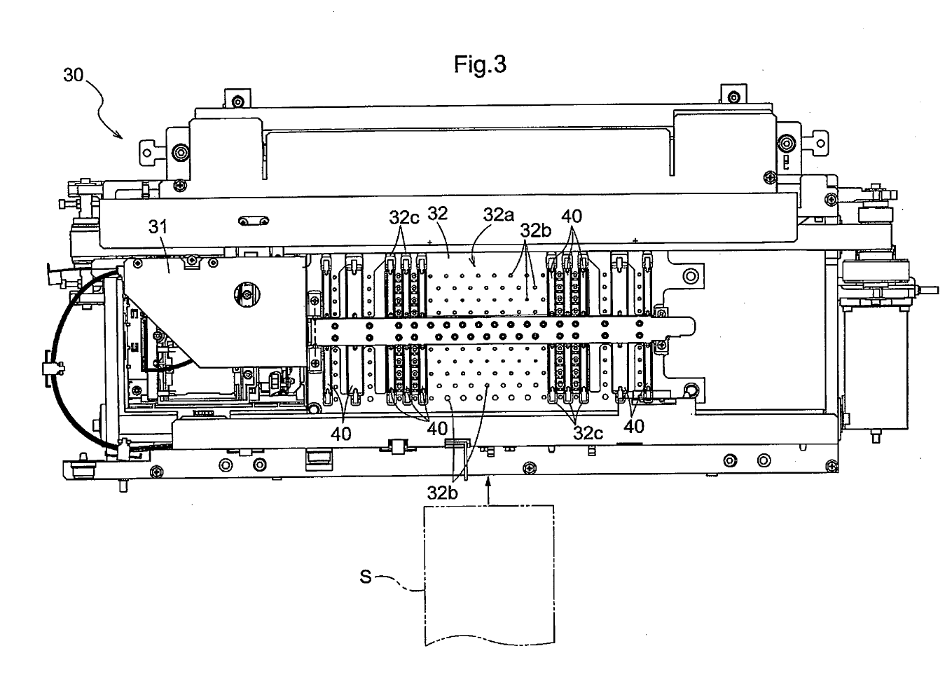

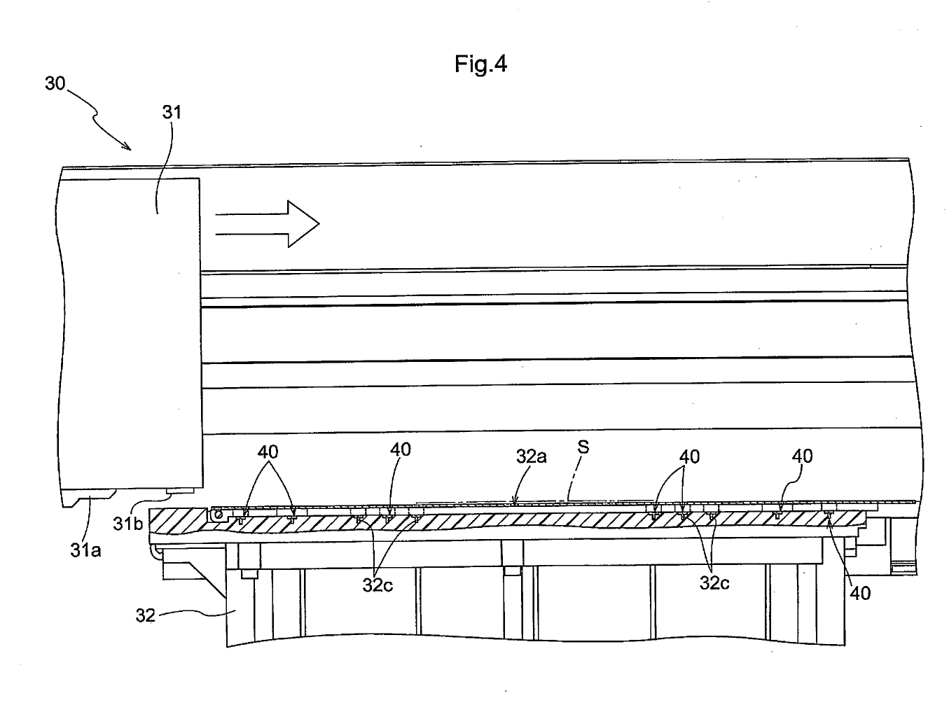

FIG. 2, FIG. 3 and FIG. 4 are a perspective view, a plane view and a side view in section of the printing section 30, respectively. As shown in these drawings, the printing section 30 includes a print head 31 disposed upwardly of the printing medium S which is conveyed thereto, and an absorbing section 32 disposed downwardly of the printing medium S. The print head 31 used in the instant embodiment is configured as an ink jet type print head which includes a plurality of ink discharging sections 31a for discharging ink. In operation, as the print head 31 is moved back and forth in the direction (the transverse direction in FIG. 3) perpendicular to the conveying direction of the printing medium S, the print head 31 discharges an amount of ink onto the printing medium S, thus forming an image on this printing medium S. Incidentally, in the instant embodiment, there are provided two rows of ink discharging sections 31a along the conveying direction of the printing medium S.

Also, as shown in FIG. 3, the absorbing section 32 includes an upper face 32a (the face in opposition to the print head 31) which defines a plurality of opening portions 32b. Through these opening portions 32b, a negative pressure is applied to the printing medium S. Under the effect of this negative pressure, the printing medium S is sucked to the upper face 32a of the absorbing section 32 and rendered flat. Therefore, a printing operation can proceed in a stable manner.

As shown in FIG. 4, the upper face 32a defines a groove 32c in which ink absorbing members 40 can be fitted.

As shown in FIG. 4, the print head 31 includes a curling detecting section 31b for detecting presence/absence of curling in the printing medium S. In the instant embodiment, the curling detecting section 31b is comprised of a distance sensor configured to detect the distance from the print head 31 to the printing medium S. However, this may be comprised of any other sensor as well. Further, in the instant embodiment, the curling detecting section 31b is provided in the print head 31. However, it may be provided in a conveying path.

[Second Conveying Section]

As shown in FIG. 1, the second conveying section 50 is disposed downstream of the printing section 30 in the conveying direction. The second conveying section 50 conveys the printing medium S from the printing section 30 via the decurling mechanism 70 toward the discharge opening 3. The second conveying section 50 includes a plurality of pairs of conveyer rollers 51 that pinch and convey the image⁻formed printing medium S in the horizontal direction. Further, in the conveying path of the second conveying section 50, there is provided a cutter 52 for cutting the image-formed printing medium S into a predetermined size. This cutter 52 includes an upper blade 52a and a lower blade 52b configured to pinch the printing medium S in cooperation therebetween. In operation, as the upper blade 52a is moved vertically, the printing medium S is cut. This cutter 52 is controlled by the controlling section C.

[Decurling Mechanism]

As described above, as the printing medium S is stored in the form of a roll, the medium S has a curling (curling peculiarity) or “a kink”. The decurling mechanism 70 corrects or removes (decurls) this curling peculiarity.

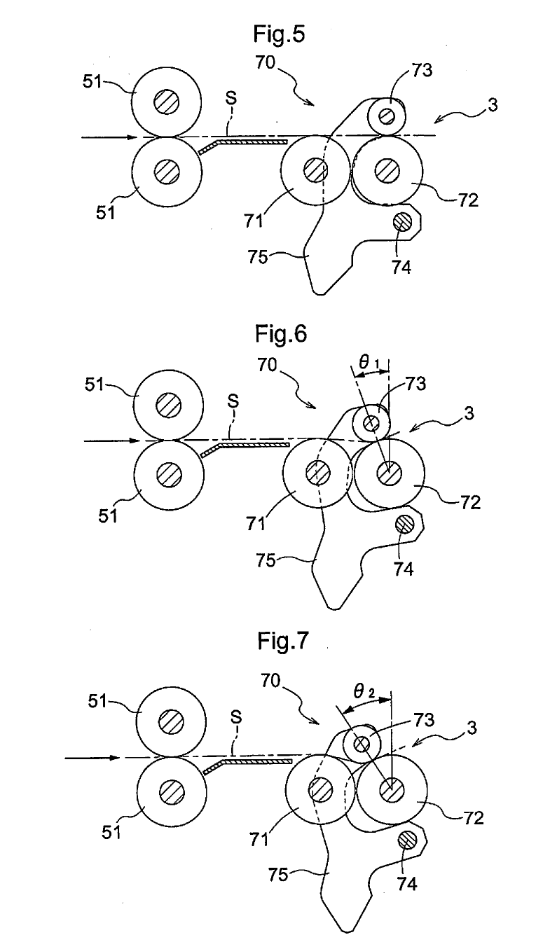

As shown in FIG. 1 and FIGS. 5 through 7, the decurling mechanism 70 consists essentially of lower rollers 71, 72 and an upper roller 73. In the instant embodiment, the upper roller 73 is supported to a roller support 75 which is mounted to be pivotable about an axis 74. As shown in FIGS. 5 through 7, the position of the upper roller 73 is varied by controlling the pivot angle of the roller support 75. The roller support 75 is operably connected with an unillustrated power source such as an actuator, a motor, etc., so that with the power from this power source, the pivot angle of the roller support 75 is varied. Further, this power source is configured to be operated based on control signals from the controlling section C.

As shown in FIG. 5, when no decurling operation is effected, the controlling section C controls the power source to pivot the roller support 75 clockwise in the illustration and causes the upper roller 73 to be positioned upwardly of the lower roller 72 disposed on the downstream side in the conveying direction. In this case, the printing medium S is conveyed with no application of decurling effect thereto. On the other hand, when curling peculiarity in the printing medium S is to be corrected (removed), the controlling section C controls the power source to pivot the roller support 75 counterclockwise in the illustration and causes the upper roller 73 to be positioned between the lower rollers 71, 72 (see FIG. 6 and FIG. 7). The pivot angles in FIG. 6 and FIG. 7 are θ₁ and θ₂, respectively and there is a relationship of θ₁<θ₂. Therefore, in the state shown in FIG. 7, the upper roller 73 is located more downwardly, so that a large decurling force can be applied.

The printing medium S that has been decurled by the decurling mechanism 70 is discharged through the discharge opening 3 onto a tray 4.

In the present invention, in order to effect a decurling operation before printing in the image forming apparatus P having the above-described arrangement, the controlling section C effects the following control. Incidentally, this control is effected only at the time of start of a printing operation.

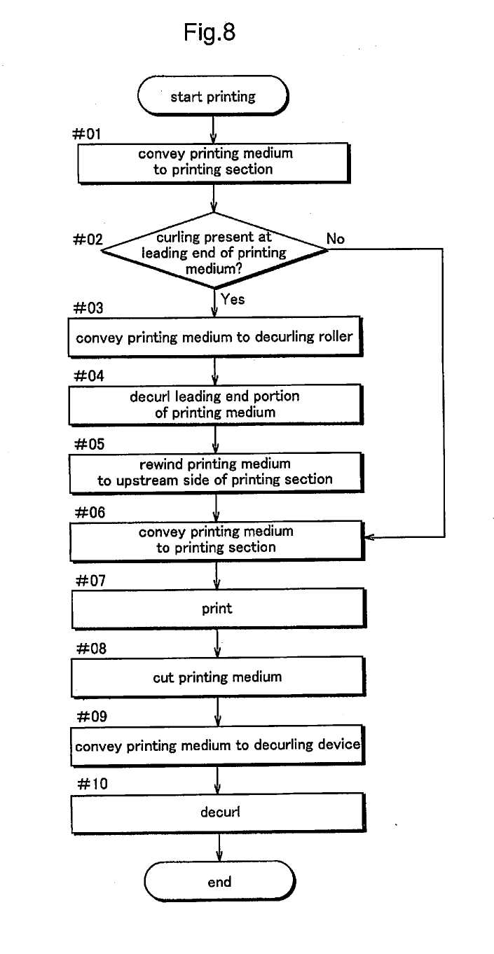

FIG. 8 is a flowchart showing flow of the controlling operation according to the instant embodiment.

As shown in FIG. 8, upon start of a printing operation, the first conveying section 10 withdraws the printing medium S and conveys this to the printing section 30 (#01). When the printing medium S is conveyed to the position of the print head 31 of the printing section 30, the print head 31 moves to the leading end portion of the printing medium S and detects presence/absence of curling by the curling detecting portion 31b provided in the print head 31. Incidentally, the above language “the absence of curling” is understood to be inclusive of a condition of a curling smaller than a predetermined amount being present. If the curling detecting section 31b detects a curling at the leading end portion of the printing medium S (YES branching at #02), the second conveying section 50 conveys the printing medium S to the decurling mechanism 70 (#03). Even when the absorbing section 32 for supporting the printing medium S flatly as in the instant embodiment, it is not possible to suck the leading end portion of the printing medium S sufficiently. For this reason, in the instant embodiment, only the leading end portion of the printing medium S (a predetermined length from the leading end) is decurled by the decurling mechanism 70 (#04). If no curling is detected at the leading end portion, the medium is conveyed to the printing section 30 without effecting any decurling (NO branching at #02).

As described above, in the instant embodiment, the curvature of the printing medium S to be used for printing when it was coiled can be detected by the curling radius detecting section 5. So, the controlling section C controls the pivot angle of the roller support 75 in accordance with this curvature. Incidentally, the pivot angle of the roller support 75 may be controlled based on such conditions as the properties of the printing medium S such as the material properties, thickness, etc. and an amount of ink used for printing. With such arrangement, a decurling force suitable for the printing medium S can be applied thereto.

After decurling, by rotating the second conveying section 50 and the first conveying section 10 in reverse, the printing medium S is rewound to the upstream side of the printing section 30 (#05). Upon completion of this rewinding, the first conveying section 10 again conveys the printing medium S to the printing section 30 (#06) and printing is effected (#07). In this, the leading end detecting section 15 detects the leading end of the printing medium S and controls the timing of operation of the print head 31.

After completion of printing, the cutter 52 cuts the printing medium S to a predetermined length (#08), whereby the predetermined length of printing medium S is obtained. Thereafter, the printing medium S is conveyed to the decurling mechanism 70 (#09), and decurling of the entire printing medium S is effected (#10).

In the instant embodiment, printing is effected by applying ink to the printing medium S. So, when ink is sprayed by the printing section 30, curling tends to appear conspicuously in the printing medium S. Especially, in the case of a photographic print, ink is sprayed over the entire surface of the printing medium S, so that the curling becomes even more conspicuous. For this reason, in the instant embodiment, the intensity of curling in the printing medium S after printing is greater than the intensity of curling in the printing medium S before printing. Therefore, control is effected such that the correcting force for the decurling after printing may be greater than the correcting force for the decurling before printing. The printing medium S decurled by the decurling mechanism 70 is discharged through the discharge opening 3 onto the tray 4.

[Other Embodiments]

(1) In the foregoing embodiment, there is provided the curling detecting section 31b for detecting presence/absence of curling at the leading end portion of the printing medium S before printing. However, this curling detecting section 31b may be omitted.

(2) In the foregoing embodiment, the curling intensity detecting section 5 is provided in order to vary the correcting force according to the intensity of curling. However, this curling intensity detecting section 5 may be omitted.

(3) In the foregoing embodiment, an arrangement is provided such that the correcting force differs between the decurling effected before printing and the decurling effected after printing. However, these correcting forces may be same.

(4) In the foregoing embodiment, there is employed an ink jet type image forming apparatus. However, the invention may be used in an image forming apparatus implementing other image forming techniques.

1. An image forming apparatus comprising:
a conveying section for withdrawing and conveying a printing medium stored in the form of a roll;
a printing section for effecting a printing operation on the printing medium;
a decurling device for correcting curling in the printing medium; and
a controlling section;
wherein the decurling device is disposed on the downstream side of the printing section; and
the controlling section controls such that a decurling operation to be effected before the printing operation and a decurling operation to be effected after the printing operation are effected by the decurling device.

2. An image forming apparatus according to claim 1, wherein the controlling section effects control such that the decurling operation before printing is effected only on the leading end portion of the printing medium.

3. An image forming apparatus according to claim 1, wherein the controlling section effects control such that the decurling operation before printing and the decurling operation after printing are effected with different correcting forces.

4. An image forming apparatus according to claim 1, wherein the image forming apparatus further comprises a curling detecting section for detecting presence/absence of the curling at the leading end portion of the printing medium; and
the controlling section effects control such that the decurling operation before printing is effected only when curling is detected at the leading end portion of the printing medium.

5. An image forming apparatus according to claim 1, wherein the image forming apparatus further comprises a curling intensity detecting section for detecting the intensity of the curling in the printing medium; and
the controlling section effects control such that the correcting force for the decurling operation before printing is varied according to the intensity of the curling.
